(19) United States
(12) Patent Application Publication
(10) Pub. No.: US 2005/0139468 A1
(43) Pub. Date: Jun. 30, 2005

(54) System for calibration of gas sensors

(76) Inventors: Rekapalli Krishnamohan Rao, Chennai (IN); Srinivas Kota, Chennai (IN); Meenalocahni Chander, Chennai (IN); D. Krishna Moorthy, Chennai (IN)

Correspondence Address: ARENT FOX PLLC, 1050 CONNECTICUT AVENUE, N.W., SUITE 400, WASHINGTON, DC, 20036, US

(21) Appl. No.: 10/801,611

(22) Filed: Mar. 17, 2004

Related U.S. Application Data
(63) Continuation of application No. PCT/IB03/06195, filed on Dec. 26, 2003.

(51) Int. Cl. G01N 27/26

(52) U.S. Cl. 204/401; 204/424

(57) ABSTRACT

The present invention relates to system for calibration of gas sensors and more particularly, the present invention relates to a system for characterization and calibration of bosch zirconium oxide based modified lambda sensors used in oil fired boiler stack gas oxygen measurement.

### TECHNICAL FIELD

The present invention relates to system for calibration of gas sensors. More particularly, the present invention relates to a system for characterization and calibration of Bosch zirconium oxide based modified lambda sensors used in oil fired boiler stack gas oxygen measurement.

### BACKGROUND AND PRIOR ART DESCRIPTION

Modern Automobile Engine Management Systems need a way to monitor the amount of fuel that is injected into the engine while driving on road, off road or on the track. It is a normal practice to introduce the lambda (Oxygen) sensor in the exhaust system for accurate measurement of free Oxygen in exhaust gases.

The Lambda meter or Lambda Display subsystem feeds this Oxygen information to an electronic control unit to adjust the air/fuel ratio to the optimum value for the vehicles fitted with catalytic converters. This subsystem also indicates the air/fuel ratio on the colour coded LED indicators, ranging from rich to lean mixtures, typically 12.5:1 to 15.0:1 A.F.R. when using regular pump fuels.

As the production quantities of Lambda sensors are very high for Automobile market, they are being produced at most economical price.

Some of the companies that produce lambda sensors for automobile market and description of their product are given below.

Mustang Dynamometer's Professional Lambda Meter (MD-PLM) accurately determines exhaust gas mixture strength over a wide range of engine operating conditions with a fast response time. This device has been designed to be quick and easy to use, whilst allowing a calibration engineer all of the power and configurability required for OE emissions development and certification work. The display may be set to show Lambda, Air Fuel Ratio or Equivalence Ratio for any sensor compatible fuel (Gasoline/Petrol, Alcohol, Gas, Diesel or “blend” fuel as defined by the user). The resolution of the display (decimal points), display update rate, display filtering, backlight intensity may all be defined by the user with the Windows setup software provided.

T026 Lambda Display System is meant for high performance engine tuning using Engine Management technology. It is a cost effective option to Dyno/Rolling Road tuning. This will enable one to accurately monitor the fuelling characteristics of the engine while driving on road, off road, or on the track in order to assess the calibration of the fuel system whether it be fuel injection or carburetor. It is a light weight lambda display unit and a heated lambda (Oxygen) sensor. The sensor accurately detects the amount of free Oxygen in the exhaust gases. The display meter ustilises this information to indicate the air/fuel ratio on the colour coded LED lights, ranging from rich to lean mixtures.

On the other hand in process control industries, Oxygen sensors are used mostly to monitor stack gas Oxygen. The production quantities of these sensors are not very high and they continue to remain as very expensive devices.

In recent years, some interest has generated to use the low cost lambda sensors for measuring the Oxygen content in fuel fired boiler or furnace stack gases. Some manufacturers started producing the variations of usual lambda sensors to suit these applications.

Companies that are manufacturing the Zirconium Oxide based instrumentation meant for stack gas oxygen measurements. The names of the companies include:
a. Panametric Inc., USA: It is designed to be a simple, low-cost, in situ, flue-gas Oxygen transmitter based on conventional Zirconium Oxide sensor for stack gas oxygen measurements in a conventional way. It is not based on lambda sensor and
b. Monitor Labs, Inc., USA: The special features of this flue gas analyzer include rugged industrial design, rapid response to changing flue conditions and achieving of sample integrity. However the probe is conventional and not based on lambda sensor.

Literature survey of the gasification Archive revealed the following.
1. In 2001, Roberto Kopper started the discussion on the possibility of using lambda sensors for stack gas Oxygen measurement for optimizing the combustion process.
2. In the same year, Alex English shared his experiences of using the Ziroconium Oxide sensor of car for monitoring the Oxygen in cooled stack gas associated with Propane burner and oil fired boiler.
3. Dr. Kaupp enriched this discussion by informing about a specially made sensor of Bosch for combustion systems.

Thus, it can be seen that the ultimate interest is to reduce the cost of the instruments which can be used for measuring oxygen in stack gases. Also, it is now high time to characterize these special lambda sensors and to establish the feasibility of their use for stack gas oxygen measurements.

### OBJECTS OF THE PRESENT INVENTION

The main object of the present invention is to provide a system for characterization and calibration gas sensors.

Another object of the present invention is to provide a system for characterization and calibration of Bosch zirconium oxide based modified lambda sensors used in oil fired boiler stack gas oxygen measurement.

### SUMMARY OF THE PRESENT INVENTION

Accordingly, the present invention provides a system for calibrating Bosch zirconium oxide based modified lambda sensors used in oil fired boiler stack gas oxygen measurement, said system comprising:
a muffle furnace attached to a gas selection mechanism, wherein said muffle furnace is being provided with the gas sensor which is to be characterized and a temperature sensor;
the gas selection mechanism supplies a predetermined amount of an air containing a predetermined quantity of the gas to be detected to the muffle furnace;
the gas sensor and the temperature sensors being coupled to a micro converter through a buffer and offset amplifier mechanism and a signal conditioning mechanism respectively;
an output from the micro converter is coupled to a display unit for displaying the values measured by the gas and the temperature sensors.

### DETAILED DESCRIPTION OF THE PRESENT INVENTION

Accordingly, the present invention provides a system for characterization and calibration of gas sensors, said system comprising:
a muffle furnace attached to a gas selection mechanism, wherein said muffle furnace is being provided with the gas sensor which is to be characterized and a temperature sensor;
the gas selection mechanism supplies a predetermined amount of an air containing a predetermined quantity of the gas to be detected to the muffle furnace;
the gas sensor and the temperature sensors being coupled to a micro converter through a buffer and offset amplifier mechanism and a signal conditioning mechanism respectively;
an output from the micro converter is coupled to a display unit for displaying the values measured by the gas and the temperature sensors.

In an embodiment of the present invention, the muffle furnace heats the air coming from the gas selection mechanism to a predetermined value to enable the gas sensor to detect and measure the amount of particular gas.

In another embodiment of the present invention, the gas sensor used is oxygen sensor.

In yet another embodiment of the present invention, the gas sensor used is a modified lambda sensor for measuring oxygen.

In still another embodiment of the present invention, the gas sensor is a Bosch zirconium oxide based modified lambda sensors used in oil fired boiler stack gas oxygen measurement.

In one more embodiment of the present invention, the gas selection mechanism supplies air containing predetermined quantity of oxygen to the muffle furnace.

In one another embodiment of the present invention, the gas selection mechanism consists of a plurality of calibrated gas cylinders containing air having predetermined quantity of oxygen, each of the said cylinder being provided with a control mechanism for controlling the amount air supplied and said calibrated gas cylinders being coupled to a channel selector for controlling the nature of air being supplied to the muffle furnace.

In a further embodiment of the present invention, the gas selection mechanism consists of 6 cylinders containing air having 0%, 2%, 4%, 6%, 8% and 10% oxygen.

In another embodiment of the present invention, the gas cylinders are provided with solenoid valves for controlling the amount of air supplied to the muffle furnace.

In yet another embodiment of the present invention, the gas cylinders are further provided with actuators for controlling the solenoids.

In still another embodiment of the present invention, the calibrated gas cylinders are coupled to the channel selector optionally through rotameters, which indicates the pressure.

In one more embodiment of the present invention, the micro converter converts the output of the gas sensor and the temperature sensor to digital values.

In one another embodiment of the present invention, the micro converter used is AduC812 micro converter.

In a further embodiment of the present invention, the display unit used is a 7-segment LED display unit.

In a further more embodiment of the present invention, a database access system for logging the readings of the gas sensor and the temperature sensor is optionally provided.

In the following paragraphs the components of the system and their working are described in detail.

### BRIEF DESCRIPTION OF THE ACCOMPANYING DRAWINGS

In the drawings accompanying the specification,

FIG. 1 shows the complete view of the gas selection set up.

FIG. 2 shows the calibrated gas cylinders (6) attached to the actuators for controlling the solenoid valves and the gas flow control through rotameter.

FIG. 3 shows the database access system for feeding the readings of the gas sensor and the temperature sensor, the temperature controller for the muffle furnace and the muffle furnace.

FIG. 4 shows the oxygen measurement system developed using Analod Devices ‘AduC812 Micro Conveter’.

FIG. 5 shows the Interfacing between the oxygen measurement system and the display device.

### GAS SELECTION SETUP FOR CHARACTERISATION

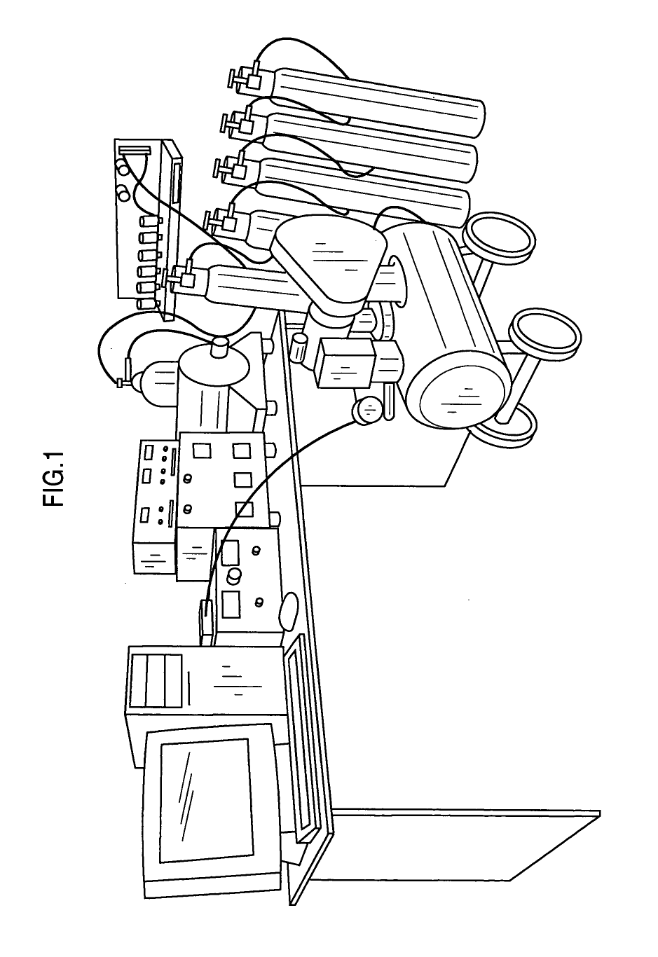

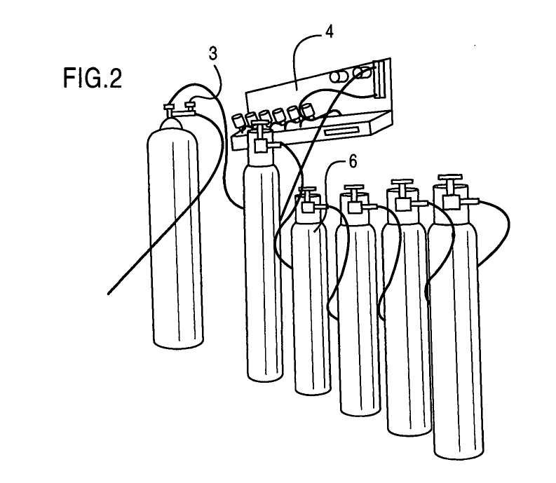

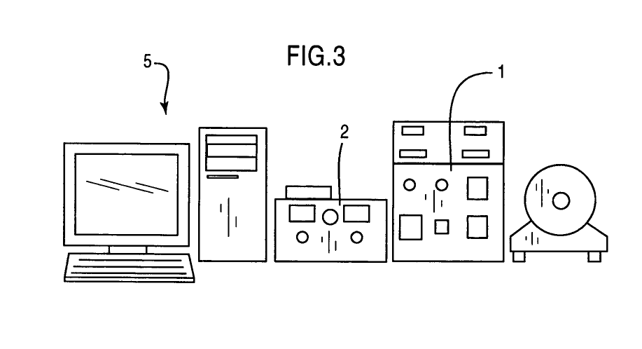

Oxygen sensor test setup has been made to test one batch of the modified lambda sensors along with the associated electronics. The test set-up has been created to investigate suitability of lambda sensor for practical application by knowing its characteristics. It consists of muffle furnace for heating the oxygen gas upto 400 degrees and automatic gas selection mechanism. The calibration gas selection setup consists of channel selector and 6 cylinders containing 0%, 2%, 4%, 6%, 8% and 10% oxygen. To select a particular % of gas, the cylinder is selected by opening the solenoid valve and gas at constant pressure is allowed to pass through the cannel selector. The pressure of gas is seen in ‘rotameter’ connected between the cylinder and channel selector. Photographs of the gas selection setup are given in FIGS. 1 to 3.

As can be seen from FIGS. 1 to 3, the gas selection setup consists of:
1. Muffle furnace
2. Temperature controller for muffle furnace
3. Actuators for controlling the solenoid valves
4. Gas Flow control through Rotameter
5. Database access system (DAS) for data logging of oxygen sensor output and temperature at the sensor
6. Calibrated gas cylinders
   Oxygen Measurement System:

Oxygen measurement system using modified lambda sensors was developed and evaluated with the sensors. The following sections briefly discusses about the system and its specifications, Characterization test setup, and evaluation of sensor results.

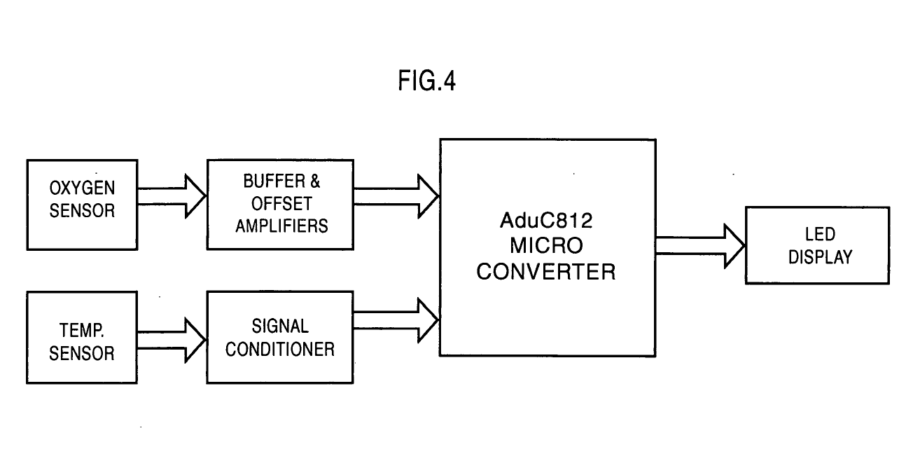

The oxygen measurement system was developed using Analog Devices ‘AduC812 Micro Converter’ based on 8051 micro-controller architecture is shown in FIG. 4. The system acquires data from oxygen sensor and temperature sensor then process the data and displays the concentration of oxygen in percentage and temperature of the flue gas in Degrees of Centigrade on 7-segment LED display.

The sensor output ranges from −10 mV to 820 mV. The signal conditioner for oxygen sensor has following stages:
Buffer Amplifier Stage: used as voltage buffer to avoid impedance mismatch.

Back-up Stage: As the sensor output voltage for 21% 62 (i.e. −10 mV) is negative, so it goes out of the range of ADC (range is 0 to 2.5V). Therefore, output voltages of the sensor is added to +10 mV to make the output always positive.

One of the most widely used devices for temperature measurement is the thermocouple. For sensing the temperature of the gas, the K-type thermocouple used. A circuit that provides the cold junction compensation along with amplification and open thermocouple detection is used for thermocouple signal conditioning.

Display & Interfacing System:

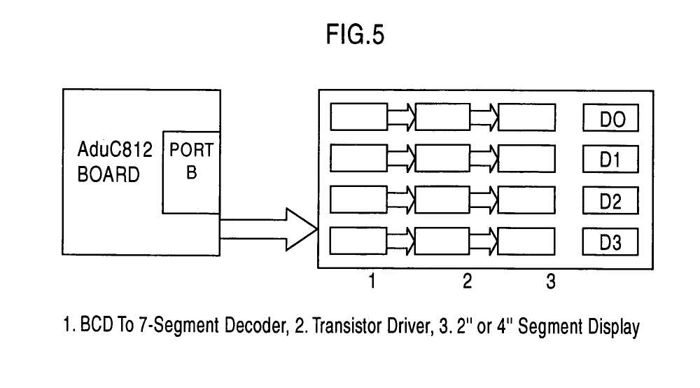

Two different sizes displays module developed for the oxygen sensor setup. They display percentage of oxygen in the range of 0 to 21% and temperature between 0 to 999° C. The interfacing is shown in FIG. 5:
1. 2″ 7-segment Display
2. 4″ 7-segment Display

Port B of AduC812 is connected to the CMOS BCD-to-7-Segment Latch Decoder Driver CD4511B. Lamp Test (LT), Banking (BL) and Latch Enable or Strobe inputs are provided, shut off or intensity -modulate it, and store or strobe a BCD code, respectively.

The specifications of the oxygen measurement system thus developed is given in table 1.

Testing and Results:

Testes were conducted for characterization of different sensors. The results are enclosed in table 2. The oxygen measurements system was assembled and tested with the simulated mV source for oxygen sensor. The results were as per the theoretical calculated values. The tests arrive at the calibration coefficients in the microcontroller for the oxygen measurement system with the calibration gases is undergoing.

TABLE 1
SYSTEM SPECIFICATIONS
Oxygen measurement system

| | |
|---|---|
| Voltage | 220 V ac 50 Hz |
| Display | 4″ 7 Segment LED |
| Warm up time | 15 minutes at 20° C. |
| Operating heater voltage | 12-V |
| Normal operating | 5-35° C. |
| temperature | |
| Outputs | RS485 - data streamed on demand |
| Calibration | Requires 2 user-selectable gas compositions |
| | (air is default plus another) |
| Thermocouple | Type K fitted to standard compensated plug |
| | Range 0-999° C. accuracy ±1° C. |
| Data logging | 1 week data at 15 minutes interval |

Sensor

| | |
|---|---|
| Cable | 2 m high temperature silicone sheathed cable, |
| | fully shielded. Nickel quick release plug |
| Max sustained gas | 300° C. |
| temperature | |
| Temperature of | 150 to 200° C. |
| metal housing | |
| Life expectancy | >10,000 hours |
| Range of measurement | 10e⁻¹⁷ ppm to 10% O₂ |
| Response time (@ gas | approximately 1-4 secs for a 90% step change |
| flow rate 1 l · min⁻¹) | (eg from 21% to 100% O₂) |
| Accuracy | ±1% of the actual oxygen concentration |
| Precision of | ±0.5% of the reading |
| measurement | |

The output of the Oxygen sensors (1-10) with the theoretical value

Theoretical e.m.f. values for different partial pressure of oxygen:
emf=2.303 RT/4F log{pO₂(Ref)/pO₂}
Temperature in K=573° K (300° C.)
Universal Gas Constant R=8.314 J/K/mol
Faraday's constant F=96485 C/mol
pO₂ (ref)=Reference Partial Pressure of Oxygen (20.9%)

pO₂ =Partial Pressure of the Oxygen in the Gas

TABLE 2
Response of sensors with calibration gases

| | Oxygen | Theoretical | | | | | | | | | | SEN |
|---|---|---|---|---|---|---|---|---|---|---|---|---|
| S. No | (%) | emf (mV) | SEN 1 | SEN 2 | SEN 3 | SEN 4 | SEN 5 | SEN 6 | SEN 7 | SEN 8 | SEN 9 | 10 |
| 1 | 0 | ∞ | 831 | 795 | 946 | 918 | 842 | 937 | 840 | 912 | 861 | 882 |
| 2 | 2.05 | 29.21 | 40 | 31.5 | 39 | 38 | 36 | 35 | 37 | 34 | 33 | 33 |
| 3 | 4.24 | 20.068 | 24 | 19 | 26 | 24 | 21 | 20 | 22 | 20 | 19 | 19 |
| 4 | 6.24 | 15.207 | 16 | 12.2 | 18 | 16 | 13 | 12 | 13 | 12 | 12 | 12 |
| 5 | 8.65 | 11.098 | 9 | 6.4 | 12 | 9 | 6 | 6 | 6 | 5 | 5 | 5 |
| 6 | 10.28 | 8.926 | 5 | 3.2 | 9 | 5 | 3 | 2 | 3 | 2 | 2 | 2 |
| 7 | 21 | −0.015 | −9 | −9.1 | −4 | −8 | −12 | −10 | −11 | −11 | −11 | −11 |

1. A system for characterization and calibration of gas sensors, said system comprising:
a muffle furnace attached to a gas selection mechanism, wherein said muffle furnace is being provided with the gas sensor which is to be characterized and a temperature sensor;
the gas selection mechanism supplies a predetermined amount of an air containing a predetermined quantity of the gas to be detected to the muffle furnace;
the gas sensor and the temperature sensors being coupled to a micro converter through a buffer and offset amplifier mechanism and a signal conditioning mechanism respectively;
an output from the micro converter is coupled to a display unit for displaying the values measured by the gas and the temperature sensors.

2. A system as claimed in claim 1, wherein the muffle furnace heats the air coming from the gas selection mechanism to a predetermined value to enable the gas sensor to detect and measure the amount of particular gas.

3. A system as claimed in claim 1, wherein the gas sensor used is oxygen sensor.

4. A system as claimed in claim 1, wherein the gas sensor used is a modified lambda sensor for measuring oxygen.

5. A system as claimed in claim 1, wherein the gas sensor is a Bosch zirconium oxide based modified lambda sensors used in oil fired boiler stack gas oxygen measurement.

6. A system as claimed in claim 1, wherein the gas selection mechanism supplies air containing predetermined quantity of oxygen to the muffle furnace.

7. A system as claimed in claim 1, wherein the gas selection mechanism consists of a plurality of calibrated gas cylinders containing air having predetermined quantity of oxygen, each of the said cylinder being provided with a control mechanism for controlling the amount air supplied and said calibrated gas cylinders being coupled to a channel selector for controlling the nature of air being supplied to the muffle furnace.

8. A system as claimed in claim 6, wherein the gas selection mechanism consists of 6 cylinders containing air having 0%, 2%, 4%, 6%, 8% and 10% oxygen.

9. A system as claimed in claim 6, wherein the gas cylinders are provided with solenoid valves for controlling the amount of air supplied to the muffle furnace.

10. A system as claimed in claim 8, wherein the gas cylinders are further provided with actuators for controlling the solenoids.

11. A system as claimed in claim 6, wherein the calibrated gas cylinders are coupled to the channel selector optionally through rotameters, which indicates the pressure.

12. A system as claimed in claim 1, wherein the micro converter converts the output of the gas sensor and the temperature sensor to digital values.

13. A system as claimed in claim 1, wherein the micro converter used is AduC812 micro converter.

14. A system as claimed in claim 1, wherein the display unit used is a 7-segment LED display unit.

15. A system as claimed in claim 1, wherein a database access system for logging the readings of the gas sensor and the temperature sensor is optionally provided.
